(19) United States
(12) Patent Application Publication
(10) Pub. No.: US 2026/0087091 A1
(43) Pub. Date: Mar. 26, 2026

(54) WORK GRAPH-BASED SPARSE LINEAR ALGEBRA OPERATIONS FOR PARALLEL PROCESSORS

(71) Applicant: ADVANCED MICRO DEVICES, INC., Santa Clara, CA (US)

(72) Inventors: William Peter Ehrett, Austin, TX (US); Bradford Michael Beckmann, Kirkland, WA (US); Paul Fridtjof Trojahn, Munich (DE); Dominik Joerg Baumeister, Munich (DE); Fabian Robert Sebastian Wildgrube, Mönkeberg (DE)

(21) Appl. No.: 18/895,657

(22) Filed: Sep. 25, 2024

(51) Int. Cl. G06F 17/16

(52) U.S. Cl. CPC G06F 17/16

(57) ABSTRACT

A processor includes a plurality of processing elements. The processor is configured to execute a work graph including a plurality of nodes representing kernels executable by one or more processing elements of the plurality of processing elements. A first processing element of the one or more of the processing elements associated with a first node of the plurality of nodes is configured to assign each logical division of a sparse input matrix to a bin of a plurality of bins. Responsive to a dispatch condition associated with a bin of the plurality of bins, the processor is configured to dispatch a workgroup to at least a second processing element associated with at least a second node of the plurality of nodes corresponding to the bin. The workgroup includes a plurality of work items based on one or more logical divisions of the sparse input matrix assigned to the bin.

### BACKGROUND

Sparse matrix multiplication is an operation involving matrices in which most of the elements are zero. Instead of storing all the elements, sparse matrix formats only store the non-zero elements and their positions, leading to significant memory savings and computational efficiency. Sparse matrix operations are useful in various applications where the datasets are large but sparsely populated with non-zero values. Sparse matrix-vector multiplication (SpMV) is a specific type of sparse matrix multiplication where a sparse matrix is multiplied by a dense vector. This operation is implemented in many computational fields, including graph analytics, machine learning, and high-performance computing (HPC). In these areas, SpMV is used to perform operations, such as solving linear systems, performing eigenvalue calculations, and implementing iterative methods.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example computing system in accordance with some implementations.

FIG. 2 is a more detailed block diagram of a computing system, such as the computing system of FIG. 1, in accordance with some implementations.

FIG. 3 is a block diagram illustrating the computing system of FIG. 2 implementing a work graph for performing sparse linear algebra operations, such as sparse matrix-vector multiply, in accordance with some implementations.

FIG. 4 and FIG. 5 together are a flow diagram illustrating an example of an overall process for performing sparse linear algebra operations, such as sparse matrix-vector multiply, using a work graph executing at a processor in accordance with at least some implementations.

FIG. 6 is a flow diagram illustrating an example of a binning data caching process that can be implemented during work graph-based sparse linear algebra operations in accordance with at least some implementations.

### DETAILED DESCRIPTION

Sparse Matrix-Vector Multiply (SpMV) is a sparse linear algebra operation implemented in various computational fields, including graph analytics, machine learning (ML), and high-performance computing (HPC) applications, such as High-Performance Conjugate Gradient (HPCG) and Large-scale Atomic/Molecular Massively Parallel Simulator (LAMMPS). SpMV operations are important due to their prevalence in customer-critical workloads on both central processing units (CPUs) and parallel processors, such as graphics processing units (GPUs). Emerging areas, such as Basic Linear Algebra Subprograms (BLAS)-based graph analytics, graph neural networks, and general-sparsity-based artificial intelligence (AI) workloads also rely on efficient SpMV operations.

SpMV involves multiplying a sparse matrix with a vector, where the sparse matrix contains a significant number of zero elements. This sparsity introduces several performance challenges, especially in parallel computing environments, such as thread divergence, where different threads in a parallel processor follow different execution paths, severely degrading performance. Ensuring high device occupancy, or the effective utilization of computational resources, is difficult due to the varying number of non-zero elements per matrix row. A straightforward approach that assigns one thread per matrix row may lead to poor performance with irregular row lengths, causing long latency tails. Additionally, the need to launch multiple kernels to handle different parts of the matrix can introduce significant overheads, especially if the preprocessing is performed on the CPU and requires data transfers to the GPU.

Conventional methods to address the challenges of sparse linear algebra operations, such as SpMV operations, often rely on preprocessing the sparse matrix to optimize computation. For instance, preprocessing can assign specific rows to specific workgroups based on the number of non-zero elements within a row. While this can improve SpMV performance, it comes with several drawbacks, such as being slow and resource-intensive, especially when performed on the CPU, which necessitates data movement between the host and the device, further adding to the overhead. The need to orchestrate multiple kernel launches and manage data transfers between kernels increases the complexity of the code, as kernel output data often require explicit cache residency control or problem tiling, adding to the programming burden. Moreover, performing parallel sparse linear algebra operations like SpMV typically involves various performance considerations, including thread divergence, device occupancy, input and output locality, and kernel launch overheads. A simple SpMV that assigns one thread per matrix row may perform poorly due to long latency tails with irregular row lengths, while another SpMV using multiple threads per row would suffer from poor device occupancy with shorter rows. Techniques such as moving preprocessing to the GPU and sorting rows into power-of-2 size bins can speed up preprocessing but still require complex and costly host-side code to orchestrate the necessary kernel launches. Despite preprocessing, achieving a balanced load across threads remains challenging due to the inherent irregularity of sparse matrices.

As such, the techniques described herein provide for the efficient computation of sparse linear algebra operations at a processor by leveraging work graphs and binning nodes, which simplifies complex indexing operations and optimizes the performance of the processor performing the sparse linear algebra operations. As described below, a processor, in at least some implementations, utilizes a work graph mechanism to complete sparse linear algebra operations, such as sparse matrix-vector multiply (SpMV) operations, in a more efficient manner than current approaches. In at least some implementations, this is achieved through a combination of binning nodes that input sparse matrix data or metadata, map finer-grain work items (e.g., work items that describe subsets of data, rows, partial rows, temporary metadata, etc.) to one or more downstream processing (consumer) nodes, and process these work items to produce partial results. The processing nodes then accumulate their partial results directly into a final output storage location or output to an additional downstream node or nodes for further processing. The number of nodes in the graph, in at least some implementations, varies depending on the input, with some nodes being unused if the input matrix has a specific structure. Additionally, different nodes, in at least some implementations, consume different numbers of work items, with some nodes coalescing multiple work items into a single workgroup launch and others launching one or more workgroups for each work item.

In at least some implementations, a binning mechanism is used to efficiently perform SpMV operations. In these implementations, the binning node takes in matrix data stored in a compressed form (e.g., Compressed Sparse Row-formatted data) and computes the length of each row in the matrix. The binning node then sends the corresponding logical division identifier (ID), such as a row ID, to a processing node that is appropriate for the row length. The processor monitors how many work items are available to each processing node and dispatches workgroups of the processing nodes (or the binning node) according to how much work is available to each processing node, cache locality, or other heuristics.

The processor, in at least some implementations, implements a caching mechanism to provide for the caching and reuse of binning data, allowing for significant reductions in overhead and improved performance when performing multiple operations on the same input matrix. For example, when using SpMV in an iterative solver application, many different input vectors may be multiplied with the same sparse matrix over the course of the application's execution. Therefore, to avoid redundant overhead of the binning node in such cases, the processor caches the binning data during the first operation on a given sparse input matrix. During subsequent operations on the same matrix, the cached binning data is reused to launch the processing nodes directly, rather than re-launching the binning node. This reduces the need to launch the binning node again and enables more efficient execution and increased performance of the processor.

As such, the techniques described herein provide for a processor to more efficiently compute sparse linear algebra operations than conventional techniques across multiple different computational domains. The use of work graphs and binning nodes enables the processor to manage fine-grained work items, eliminating the need for complex indexing operations typical in traditional methods. Moreover, the implementation of processor heuristics that monitor work item availability and dispatch workgroups based on cache locality or other performance-critical factors provides adaptability, enabling the processor to optimize performance in various execution scenarios. Also, by leveraging parallel processing capabilities and the work graph mechanism described herein, these techniques significantly boost performance and scalability, making complex computations more manageable. It should be understood that although the techniques described herein are discussed with respect to Compressed Sparse Row (CSR) formatted data, these techniques are also applicable to other types of formatted data, such as Compressed Sparse Column (CSC) formatted data.

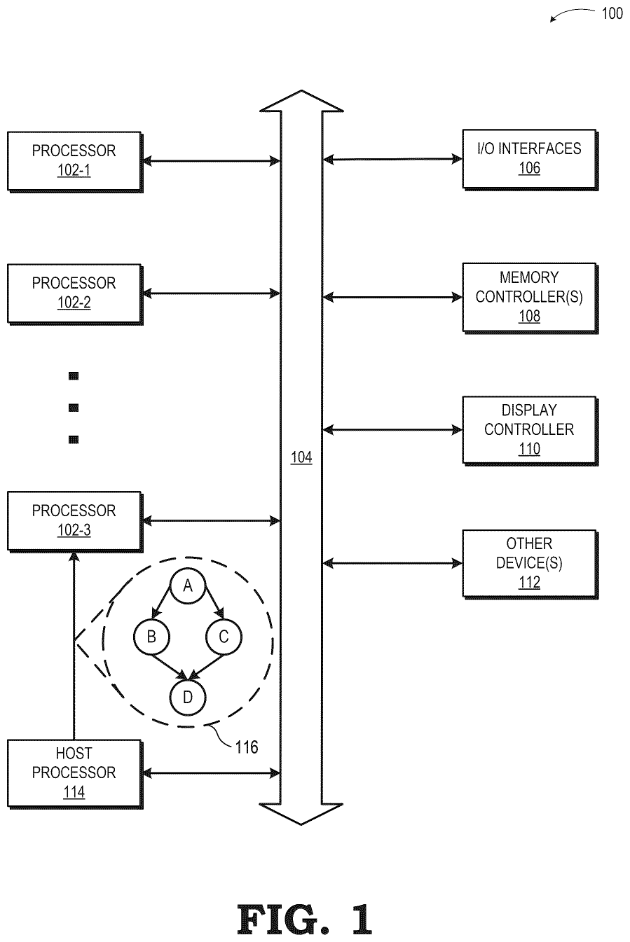

FIG. 1 illustrates a block diagram of a computing system 100 that leverages work graphs and binning nodes to efficiently compute sparse linear algebra operations, including SpMV operations, by simplifying complex indexing operations and optimizing processor performance in accordance with at least some implementations. The computing system 100, in at least some implementations, includes at least one or more processors 102 (illustrated as processors 102-1 to 102-3), a fabric 104, input/output (I/O) interfaces 106, a memory controller(s) 108, a display controller 110, and other devices 112. In at least some implementations, to support execution of instructions for graphics and other types of workloads, the computing system 100 also includes a host processor 114, such as a central processing unit (CPU). The computing system 100, in at least some implementations, is a computer, laptop, mobile device, server, gaming device, or any of various other types of computing systems or devices. It is noted that the number of components of the computing system 100 may vary. It is also noted that in implementations computing system 100 includes other components not shown in FIG. 1, and the computing system 100, in at least some implementations, is structured differently than shown in FIG. 1.

The fabric 104 is representative of any communication interconnect that complies with any of various types of protocols utilized for communicating among the components of the computing system 100. The fabric 104 provides the data paths, switches, routers, and other logic that connect the processors 102, I/O interfaces 106, memory controller(s) 108, display controller 110, and other devices 112 to each other. The fabric 104 handles the request, response, and data traffic, as well as probe traffic to facilitate coherency. Interrupt request routing and configuration of access paths to the various components of the computing system 100 are also handled by the fabric 104. Additionally, the fabric 104 handles configuration requests, responses, and configuration data traffic. In at least some implementations, the fabric 104 is bus-based, including shared bus configurations, crossbar configurations, and hierarchical buses with bridges. In other implementations, the fabric 104 is packet-based, and hierarchical with bridges, crossbar, point-to-point, or other interconnects. From the point of view of the fabric 104, the other components of computing system 100 are referred to as “clients”. The fabric 104 is configured to process requests generated by various clients and pass the requests on to other clients.

The memory controller(s) 108 is representative of any number and type of memory controller coupled to any number and type of memory device(s). For example, the types of memory device(s) coupled to the memory controller(s) 108 include Dynamic Random Access Memory (DRAM), Static Random Access Memory (SRAM), NAND Flash memory, NOR (Not Or) flash memory, Ferroelectric Random Access Memory (FeRAM), or others. The memory controller(s) 108 is accessible by the processors 102, I/O interfaces 106, display controller 110, and other devices 112 via the fabric 104. The I/O interfaces 106 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to the I/O interfaces 106. Such peripheral devices include (but are not limited to) displays, keyboards, mice, printers, scanners, joysticks or other types of game controllers, media recording devices, external storage devices, network interface cards, and so forth. The other device(s) 112 are representative of any number and type of devices (e.g., multimedia device, video codec, or the like).

In at least some implementations, one or more of the processors 102 are a parallel processor (e.g., vector processors, graphics processing units (GPUs), general-purpose GPUs (GPGPUs), non-scalar processors, highly-parallel processors, artificial intelligence (AI) processors, inference engines, machine learning processors, neural processing units (NPUs), intelligence processing units (IPUs), other multithreaded processing units, digital signal processors (DSPs), field programmable gate arrays (FPGAs), application-specific integrated circuits (ASICs), and the like. Each parallel processor 102, in at least some implementations, is constructed as a multi-chip module (e.g., a semiconductor die package) including two or more base integrated circuit (IC) dies communicably coupled together with bridge chip(s) or other coupling circuits or connectors such that a parallel processor is usable (e.g., addressable) like a single semiconductor integrated circuit. As used in this disclosure, the terms ‘die’ and ‘chip’ are interchangeably used.

One or more other processors 102, in at least some implementations, are an accelerated processor that combines, for example, a general-purpose CPU and a GPU. The AP accepts both compute commands and graphics rendering commands from the host processor 114 or another processor 102. The AP includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. APs may include some of the aforementioned processors, such as GPUs, AI processors, inference engines, machine learning processors, NPUs, IPUs, and the like. The AP and the host processor 114, in at least some implementations, are formed and combined on a single silicon die or package to provide a unified programming and execution environment. In other implementations, the AP and the host processor 114 are formed separately and mounted on the same or different substrates.

Each of the individual processors 102, in at least some implementations, includes one or more base IC dies employing processing chiplets. The base dies are formed as a single semiconductor chip including N number of communicably coupled graphics processing stacked die chiplets. In at least some implementations, the base IC dies include two or more direct memory access (DMA) engines that coordinate DMA transfers of data between devices and memory (or between different locations in memory).

In at least some implementations, parallel processors, accelerated processors, and other multithreaded processors 102 implement multiple processing elements (not shown) (also referred to herein as “processor cores” or “compute units”) that are configured to execute concurrently or in parallel multiple instances (threads or waves) of a single program on multiple data sets. Several waves are created (or spawned) and then dispatched to each processing element in a multi-threaded processor. In implementations, a processing unit includes hundreds of processing elements so that thousands of waves are concurrently executing programs in the processor. The processing elements in a GPU typically process three-dimensional (3-D) graphics using a graphics pipeline formed of a sequence of programmable shaders and fixed-function hardware blocks.

The host processor 114 prepares and distributes one or more operations to the one or more processors 102 (or other computing resources), and then retrieves results of one or more operations from the one or more processors 102. The host processor 114, in at least some implementations, sends work to be performed by the one or more processors 102 by queuing various work items (also referred to as “threads”) in a command buffer (not shown). A stream of commands, in at least some implementations, is recorded on the host processor 114 to be processed on a processor 102, such as a GPU or accelerated processor. Examples of a command include a kernel launch during which a program on a number of hardware threads is executed, or other hardware-accelerated operations, such as direct memory accesses, synchronization operations, cache operations, or the like. The processor 102 consumes these commands one after the other.

In at least some implementations, one or more of the processors 102 or the host processor 114 execute at least one work graph 116. A work graph 116 enables a processor 102 to autonomously process complex and divergent workloads without needing constant communication with the host processor 114. A work graph 116 represents a program composed of multiple kernels, known as nodes, organized into a graph that depicts their data flow dependencies. In at least some implementations, a workload including multiple work items is organized as a work graph 116. The dependencies of the work graph 116 can range from per-thread to workgroup or even dispatch dependencies. A node in the work graph 116 representing a kernel or program, such as a shader, is executed once its input constraints are met. Each kernel represented by a node executes on one or more processing elements (e.g., compute units) of a processor, such as processors 102 or host processor 114.

Each edge (or link) between two nodes in a work graph 116 corresponds to a dependency (e.g., a data, execution, or other type of dependency) between the nodes. To illustrate, the work graph 116 shown in FIG. 1 includes shaders forming the nodes (A to D) of the work graph 116, with edges representing dependencies between shaders. In at least one implementation, a dependency indicates when one node must wait for work or data (e.g., a payload) from another node before it can begin or continue its work. One or more processors 102, in at least some implementations, execute the work graph 116 after invocation by the host processor 114, starting at node A. As shown, the edges between node A and nodes B and C (as indicated by the arrows) indicate that at least some of the work of node A is to be completed before the work of nodes B and C can begin. In at least some implementations, the work performed at the nodes of work graph 116 includes kernel launches, memory copies, CPU function calls, or other work graphs (e.g., each of nodes A to D may correspond to a sub-graph, not shown, including two or more other nodes).

Data flows through the work graph 116 in the form of user-defined structures referred to as records, with each thread in any node capable of producing records for other nodes. When records become available, nodes are launched according to their specified launch mode. This fine-grained, on-device scheduling leads to interleaved parallel execution, maximizing the processor's hardware efficiency compared to traditional pre-recorded kernel dispatches. Examples of these launch modes include a broadcasting launch mode, a coalescing node launch mode, and a thread mode. The broadcasting launch mode resembles classic dispatches; that is, an entire grid of workgroups is launched with all threads consuming a single shared record. The dispatch grid size can either be a fixed constant for the node (“fixed expansion”) or be encoded in the record (“dynamic expansion”). The coalescing node launch mode is implemented by a coalescing node, which launch a single, fixed-size workgroup with shared access to an array of input records across the group's threads. A coalescing node specifies the maximum number of records one workgroup can handle. This allows programmers to break up divergent control flow into separate nodes that can be launched independently by the parallel processor once enough coherent input data is accumulated. Accordingly, the parallel processor runtime attempts to launch a workgroup only after the specified number of records has been accumulated. However, a workgroup may be launched with fewer records if necessary. The thread mode declares that a single thread consumes a single record in isolation. The scheduling runtime is responsible for launching coalescing and thread mode nodes with waves packed as tightly as possible, which optimizes the overall execution efficiency.

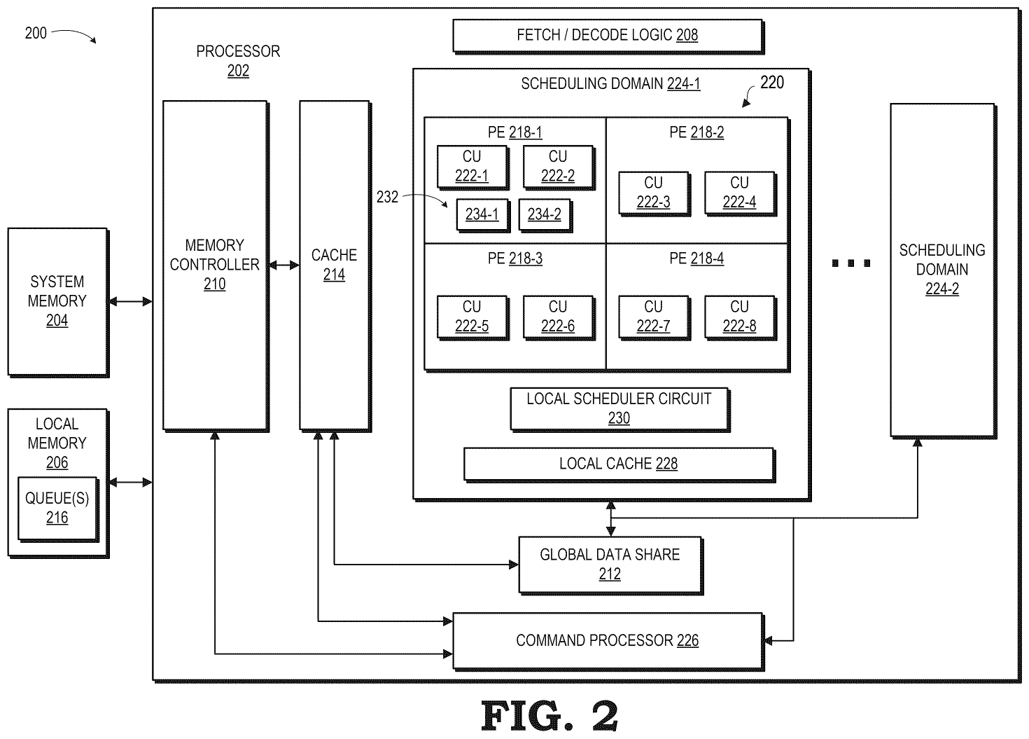

Referring now to FIG. 2, a more detailed block diagram of a computing system 200, such as the computing system 100 of FIG. 1, is shown. In at least some implementations, the computing system 200 includes one or more processors 202, such as the processors 102 of FIG. 1, system memory 204, and local memory 206 belonging to the processor 202, fetch/decode logic 208, a memory controller 210, a global data store 212 (e.g., a shared cache), and one or more levels of cache 214. The computing system 200 also includes other components that are not shown in FIG. 1 for brevity.

In at least some implementations, the local memory 206 includes one or more queues 216. In other implementations, the queues 216 are stored in other locations within the computing system 200. The queues 216 are representative of any number and type of queues that are allocated in computing system 200. In at least some implementations, the queues 216 store rendering or other tasks to be performed by the processor 202. The fetch/decode logic 208 fetches and decodes instructions in the waves of the workgroups that are scheduled for execution by the processor 202. Implementations of the processor 202 execute waves in a workgroup. For example, in at least some implementations, the fetch/decode logic 208 fetches kernels of instructions that are executed by all the waves in the workgroup. The fetch/decode logic 208 then decodes the instructions in the kernel. The global data store 212 and cache 214, respectively, store shared and local copies of data and instructions that are used during execution of the waves.

The processor 202, in at least some implementations, includes one or more processing elements (PEs) 218 (illustrated as processing elements 218-1 to 218-4). One example of a processing element 218 is a workgroup processor (WGP) also referred to herein as a “workgroup processing element”. In at least some implementations, a WGP is part of a shader engine 220 of the processor 202. Each of the processing elements 218 includes one or more compute units (CUs) 222 (illustrated as compute unit 222-1 to 222-8), such as one or more stream processors (also referred to as arithmetic-logic units (ALUs) or shader cores), one or more single-instruction multiple-data (SIMD) units, one or more logical units, one or more scalar floating point units, one or more vector floating point units, one or more special-purpose processing units (e.g., inverse-square root units, since/cosine units, or the like), a combination thereof, or the like. Stream processors are the individual processing elements that execute shader or compute operations. Multiple stream processors are grouped together to form a compute unit, a SIMD unit, or a Single Instruction, Multiple Threads (SIMT) unit. SIMD and SIMT units, in at least some implementations, are each configured to execute a thread concurrently with the execution of other threads in a wavefront (e.g., a collection of threads that are executed in parallel) by other SIMD or SIMT units, e.g., according to a SIMD or SIMT execution model. In the SIMD execution model, multiple processing elements share a single instruction stream (program control flow unit) and program counter, executing the same instruction but on different pieces of data simultaneously. In the SIMT execution model, multiple threads share a single instruction stream and program counter, allowing them to execute the same program but with different data. This model is particularly efficient in handling divergent execution paths within the same group of threads. The number of processing elements 218 in a SIMD or SIMT unit can be configured, allowing flexibility in performance and resource utilization depending on the specific computational requirements.

Each of the one or more processing elements 218 executes a respective instantiation of a particular work item to process incoming data, where the basic element of execution in the one or more processing elements 218 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing element 218.

In at least some implementations, the processor 202 includes one or more scheduling domains 224 (illustrated as scheduling domain 224-1 and scheduling domain 224-1). A scheduling domain 224 is also referred to herein as a “node processor 224” due to its processing of work at the nodes of a work graph, such as work graph 116 as previously described. In at least some implementations, a scheduling domain 224 is comprised of or is defined by a shader engine 220 which, as described above, includes one or more compute units 222 each including at least one stream processor or shader processor, one or more rasterizers, one or more graphics pipelines, one or more computer pipelines, a combination thereof, or the like. In at least some implementations, the scheduling domains 224 execute work received from a global command processor (CP) 226 (also referred to herein as a “global scheduler circuit 226”) that communicates with all of the scheduling domains 224. Each scheduling domain (e.g., shader engines 220), in at least some implementations includes a local cache 228 and also has access to the global data store (e.g., global cache) 212.

Each scheduling domain 224, in at least some implementations, includes a local scheduler circuit 230 (also referred to herein as a “work graph scheduler circuit (WGS) 230” associated with a set of processing elements 218 (e.g., WGPs). During execution of work, the local scheduler circuit 230 executes work locally in an independent manner. In other words, the local scheduler circuit 230 of a scheduling domain 224 is able to schedule work without regard to local scheduling decisions of other scheduling domains 224 (e.g., shader engines 220). Stated differently, the local scheduler circuit 230 does not interact with other local scheduler circuits 230 of other scheduling domains 224. Instead, the local scheduler circuit 230 uses a private memory region for scheduling and as scratch space. The compute units 222 of a processing element 218 execute the work items scheduled by the local scheduler circuit 230 of their scheduling domain 224.

The execution of work items by compute units 222, such as shader cores, of a processing element 218, such as a WGP, often produces payloads for consumption (i.e., execution) by one or more other compute units 222 within the same or different scheduling domain 224. For example, FIG. 1 shows that a first compute unit 222-1 generated a payload 232 including data 234 (illustrated as data 234-1 and data 234-2). The payload 232, in at least some implementations, is to be executed by one or more other processing elements 218, such as processing elements 218-2, in the same scheduling domain 224-1 as the first compute unit 218-1 or by another processing elements 218 in a different scheduling domain 224-2. In terms of a work graph, a node (e.g., a shader) in the graph generates a payload 232 that is to be executed by another node (e.g., compute unit) in the graph.

In at least some implementations, the compute units 222 are configured to write their payloads to a contiguous region of memory referred to as a memory chunk. In many instances, this memory chunk has multiple different types of payloads from multiple different nodes. Therefore, when the memory chunk is full, another computing unit is configured to sort all of the different payloads in the memory chunk. As part of the sorting operation, the sorting compute unit identifies all of the payloads that are to be executed by the same compute unit and groups these payloads together in the memory chunk. After the sorting operation has been performed, the sorting compute unit notifies a scheduler, such as a command processor 226 or local scheduler 230, which proceeds to schedule the sorted work items for dispatching to their associated compute units 222.

In other implementations, one or more sorting circuits (not shown) are implemented within the processor 202 that performs sorting or coalescing operations on payloads 232 independent of the compute unit 222 that generated the payloads 232. In at least some implementations, one or more sorting circuits (not shown) are implemented within the scheduling domains 224 of the processor 202. For example, in at least some implementations, a sorting circuit is implemented per local scheduler circuit 230 within one or more scheduling domains 224. In other implementations, a sorting is implemented per processing element 218 within one or more scheduling domains 224 of the processor.

One example of workloads performed by the computing system 200 are sparse linear algebra operations, such as sparse matrix-vector multiplication (SpMV) operations. In a Sparse Matrix-Vector Multiplication (SpMV) operation, a sparse matrix, which is a matrix with a majority of its elements being zero, is multiplied by a dense vector, which is a vector predominantly composed of non-zero elements. An SpMV operation can be described as follows: given a sparse matrix A with dimensions m×n and a dense vector x of length n, the objective is to compute a dense output vector y of length m. Each element yᵢ of y is calculated as the dot product of the i-th row of A and the vector x, expressed mathematically as

$${y}_{i} = {\sum }_{j = 1}^{n} {A}_{ij} {x}_{j}$$

for i=1, 2, . . . , m, where Aᵢⱼ are the non-zero elements of the matrix A.

Optimizing SpMV workloads for processing on parallel processors is non-trivial. For example, various data formats, such as Compressed Sparse Row (CSR), Compressed Sparse Column (CSC), and Coordinate (COO), are typically implemented to compress sparse data by storing only non-zero values, which helps avoid excessive storage and computational overhead for very large matrices. However, formats such as CSR introduce substantial irregularity in memory access patterns by requiring multiple levels of indirection. This makes it difficult to achieve high performance on data-parallel processors, such as APs or GPUs, whose compute cores and memory systems are designed for highly regular work and memory access patterns. Furthermore, since the number of non-zero values per row (row length) in a given sparse matrix can vary widely, applying a single parallel processing method to the whole problem is often inefficient. For instance, in SpMV, assigning one parallel processor thread to process each matrix row may perform poorly due to long tail latencies when row lengths vary. Meanwhile, another SpMV implementation that uses a full workgroup to process each row would suffer from poor device occupancy when processing shorter rows. Since matrix characteristics, notably non-zero elements per row, vary widely, conventional SpMV techniques often rely on costly preprocessing to achieve high performance.

Therefore, the computing system 200 leverages one or more work graphs 116 to combine SpMV (and other sparse linear algebra) preprocessing and processing on the processor 202. As described below, the processor 202 defines a work graph 116 of preprocessing steps and processing kernels that executes wholly on the processor 202, which in this example, is a parallel processor such as an AP or a GPU. The work graph 116 includes at least one binning node and multiple downstream SpMV nodes. The binning node computes row lengths in a sparse matrix and sends row IDs to the appropriate downstream SpMV node optimized for a specific row length. The entire graph is executed as one, with the processor 202 dispatching work-groups of the SpMV nodes without CPU interaction. For example, in at least some implementations, as soon as preprocessing has generated sufficient work, individual processing kernels' workgroups are self-scheduled or dispatched on-the-fly. This improves cache locality by consuming preprocessing results before they are evicted from cache, eliminates the need for host processor-parallel processor communication (e.g., CPU-GPU communication) to transfer preprocessing results and configure kernel launches, and substantially reduces API-level overheads by dispatching a single “work graph” to the parallel processor rather than numerous individual kernels.

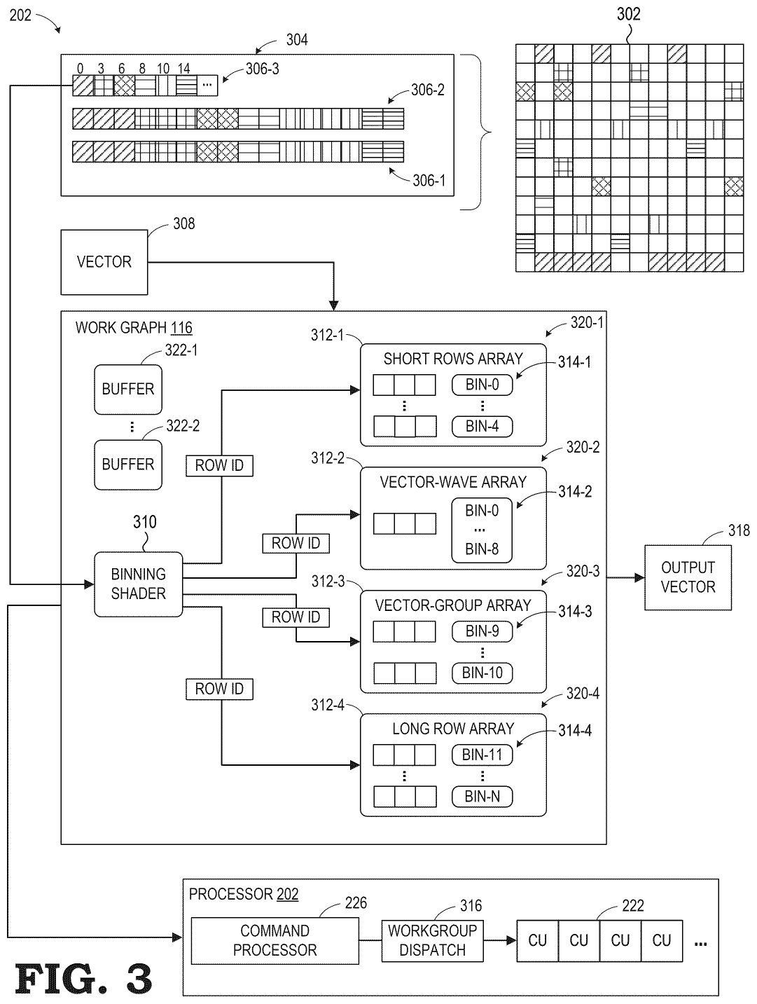

FIG. 3 shows one example of the computing system 200 implementing a work graph 116 for performing SpMV operations. It should be understood that although the following discussion is directed to SpMV operations, the techniques described herein are also applicable to other sparse linear algebra operations that rely on preprocessing, such as sparse matrix-matrix multiplication (SpMM), sparse matrix-sparse matrix multiplication (SpMSpM), sparse matrix-sparse vector multiplication (SpMSpV), and the like. The processor 202 obtains a sparse input matrix 302 as input. In at least some implementations, the processor 202 obtains the sparse input matrix 302 from system memory 204, local memory 206, a global data store 212, one or more levels of cache 214, or the like. The sparse input matrix 302, in at least some implementations, is stored in a format 304 such as a CSR format, a CSC format, or a COO format. In the example shown in FIG. 3, the sparse input matrix 302 is stored in a CSR format, which utilizes three arrays 306 (illustrated as array 306-1 to 306-3). A first array 306-1 stores the values of the non-zero elements. A second array 306-2 stores the column indices corresponding to these values. A third array 306-3 is used for indexing the starting position of each row in the value array. The processor 202, in at least some implementations, also obtains an input vector 308 (also referred to herein as “vector 308”) to be used for the SpMV operations. The input vector 308 used in SpMV is a one-dimensional array of values, typically obtained from the specific application context, such as initial conditions, intermediate solutions, rank scores, feature vectors, a combination thereof, and the like.

The processor 202 defines a work graph 116 including at least one binning node 310 and a plurality of processing nodes 312 (illustrated as processing node 312-1 to processing node 312-4). In at least some implementations, different numbers of processing nodes 310 are defined in the work graph 116 based on the configured output of the binning node 310. The processor 202 also defines a plurality of bins 314 (illustrated as bins 314-1 to bin 314-4) to group rows of the sparse input matrix 302 based on their lengths, ensuring that rows with similar numbers of non-zero elements are processed together. In at least some implementations, the bins 314 are created by analyzing the number of non-zero elements in each row and determining appropriate ranges for grouping. For instance, the bins 314 may be defined to cover rows with 1 to 16 non-zero elements, 17 to 256 non-zero elements, and so on. In at least some implementations, each bin 314 stores one or more of non-zero elements, column indices, row indices, or logical divisional identifiers (e.g., row identifiers or column identifiers) for the rows that fall within its range. In addition, or alternatively, to these items, a bin 314, in at least some implementations, stores explicit pointers to data locations in memory components (e.g., memory, cache, or scratchpad), actual row/column/tile data (rather than pointers-only), and the like. The items maintained by or associated with a bin 314 or the rows of the sparse input matrix 302 associated with a bin 314 are herein referred to as “work items”.

During the SpMV operation, each bin 314 is processed separately, with the non-zero elements in each row being multiplied by the corresponding elements in the input vector 308, and the results are accumulated to form the final output vector. Each bin 314 (or range of bins 314) corresponds to or is associated with at least one of the processing nodes 312. Stated differently, during the SpMV operation, a processing node 312 associated with a bin 314 performs the multiplication of non-zero values in the rows assigned to that bin 314 by the corresponding elements in the input vector 308, ensuring that for each row within the bin 314, every non-zero element is multiplied by the element of the input vector 308 that corresponds to the column index of the non-zero element. The resulting products are accumulated in the appropriate positions of the output or result vector 318.

The binning node 310, such as shader of a processing element 218 of the processor 202, performs preprocessing operations on the sparse input matrix 302. For example, the binning node 310 preprocesses the sparse input matrix 302 by determining the row length (i.e., the number of non-zero elements in the row) of each row in the sparse input matrix 302 and assigning the row to a bin 314 based on the determined row length. In at least some implementations, the binning node 310 is a “dynamic expansion” node that is dispatched with a grid having one thread per row of the sparse input matrix 302. Each thread computes the length of its assigned row in the sparse input matrix 302 and determines the target bin for the row given by ceil(log 2(row length)). In at least some implementations, each binning thread sends the row identifier (ID) of its assigned row to the identified target bin 314. In at least some implementations, a row ID is sent to a processing node 312 in the form of a work graph record, which is a data structure that models the tasks and their dependencies within the work graph 116.

After one or more work items are stored in a bin 314, at least one work item in the bin 314 is sent to the processing node(s) 312 associated with the bin 314. In at least some implementations, the command processor 226 monitors the number of work items available (i.e., stored in an associated bin 314) to each processing node 312. When a dispatch condition associated with a bin 314 or processing node 312 has been satisfied, the command processor 226 organizes the work items of the associated bin 314 into one or more workgroups and sends one or more workgroup dispatches 316 to the processing node 312 (e.g., one or more compute units 222). Examples of the dispatch condition include the number of work items in a bin 314 satisfying a corresponding threshold, a cache locality of the work items satisfying a corresponding threshold, or any of a variety of other possible heuristics.

When a processing node 312 receives a workgroup, the processing node 312 initializes necessary variables and states required for the SpMV operation, loads data into registers, and the like. The processing node 312 then fetches the required data from memory associated with its bin 314, including, for example, the non-zero elements of the assigned matrix rows, their column indices, and the corresponding elements of the input vector 308. For each row in the workgroup, the processing node 312 performs a dot product calculation by iterating over the non-zero elements, multiplying each by the corresponding element in the input vector 308 (determined using the column index), and accumulating the results. These accumulated results are stored in the appropriate positions in the output vector 318. In at least some implementations, the processing node 312 processes multiple rows in parallel. If the computation involves intermediate results, the processing node 312, in at least some implementations, temporarily stores these in memory. Once all assigned rows are processed, the processing node 312 combines any partial results, writes the final results back to memory, and updates the output vector 318. Upon completing the work items, the processing node 312 notifies the command processor 226, which involves, for example, updating status registers or sending an interrupt signal.

In at least some implementations, the processing nodes 312 are split into multiple node arrays 320 (illustrated as node array 320-1 to node array 320-4), with each node array 320 assigned to a different range of bins 314. In at least some implementations, the different node arrays 320 handle different types of rows. For example, the processing nodes 312 of the first node array 320-1, in at least some implementations, handle short rows, which are rows having a row length up to a first row length threshold (e.g., up to 16 non-zero elements) using, for example, a parallelization strategy referred to as “thread” launch mode. In this mode, each thread is responsible for processing a single row in isolation (i.e., without any interference or coordination with other threads). In at least some implementations, when processing short rows, the thread divergence due to different row lengths is no more than a factor of 2, which ensures that even with varying row lengths, the maximum difference in execution time between threads remains bounded.

The second node array 320-2 implements a “coalescing” launch mode, which enables efficient processing of vector-wave rows with varying lengths, also known as “row-major” data structures. In this configuration, a processing node 312 in the second node array 320-2 is optimized to handle row lengths of a second row length threshold (e.g., lengths ranging between and including 17 to 256 non-zero elements). When a row of length “n” is processed, the processing nodes 312 of the second node array 320-2 employ a loop of reductions across all threads in a single wave. In at least some implementations, the number of reductions implemented depends on the exact row length. This “reduction” process, in at least some implementations, involves aggregating values from multiple threads into a single value at each iteration, until only one thread remains. For example, the threads in each wave are initially divided into groups, with each group responsible for processing a portion of the row. At each iteration, the values from each group are aggregated and reduced to a single value using a pre-defined operation (e.g., sum, average). This reduction process continues until only one thread remains, which represents the final, aggregated result. As such, the “reduction” process coalesces (e.g., combines) the partial SpMV results computed by each thread into a single SpMv result.

The processing nodes 312 in the third node array 320-3 handle vector-group rows, which are rows having a row length satisfying a third row length threshold (e.g., lengths ranging between and including 257 elements to 1024 non-zero elements). Each processing node 312 in this node array 320-3 defines its workgroup size according to the non-zero value count of the corresponding bin 314. This allows for efficient parallel processing within each group. All threads in the group then work together to produce a final SpMV result for the node array 320-3, by first performing a wave-wide reduction step in parallel. This initial reduction step is similar to the one described above for vector-wave rows, where values are aggregated across multiple threads in a single wave. The output of this wave-wide reduction is then stored in group-shared memory, which enables a second, workgroup-wide parallel reduction step. In this step, the partially reduced values from each node within the group are combined using group-shared memory, allowing for further aggregation and reduction. This hierarchical reduction approach enables efficient processing of large vector-group rows.

The processing nodes 312 in the fourth node array 320-4 handle long rows, which are rows having a row length satisfying a fourth row length threshold (e.g., lengths greater than 1024 non-zero elements). Each processing node 312 of this node array 320-4 performs the SpMV operation for a single row collaboratively with many workgroups. For example, in at least some implementations, this process begins with each workgroup within a processing node 312 performing intra-group reduction steps on a sub-section of the long row, leveraging group-shared memory to facilitate efficient data exchange between threads. This intra-group reduction step enables the processing node 312 to produce a partial result that can be combined with others to form the final SpMV output of the node array 312-4. Once the intra-group reductions are complete, a single thread within each workgroup uses floating-point atomics to add its group's result to the overall output result, effectively accumulating contributions from all threads within the workgroup. To further optimize performance and minimize overhead, the binning node 312, in at least some implementations, is responsible for selecting a processing node 312 within the fourth node array 320-4 with a dispatch dimension that best matches the row's length, ensuring that only the necessary number of workgroups are activated in the dispatch grid.

In some implementations, all processing nodes 312 may not be utilized in the work graph 116. For example, if the sparse input matrix 302 only includes short rows, the command processor 226 (or binning node 310) does not dispatch work items to processing nodes 312 configured for long rows. Also, the number of work items consumed by different processing nodes 312 can vary, such as a processing node 312 handling short rows coalescing many work items into a single launch versus a processing node 312 processing long rows launching one or more workgroups per item. In at least some implementations, processing nodes 312 accumulate their partial results directly in a final output storage location or output to additional downstream processing nodes 312 for reduction. A processing node 312, in at least some implementations, outputs data directly back to main memory, while in other implementations, a processing node 312 preserves its data in cache or a scratchpad, which enables the work graph 116 to be used as a processing node 310 in another, higher-level graph for a full HPC application. Moreover, in at least some implementations, a processing node 312 itself includes one or more subgraphs, such as a processing node 312 processing certain-length rows with two stages (e.g., generating partial products and performing local reductions).

In some instances, multiple subsequent operations are performed using the same sparse input matrix 302 but different data for other inputs. For example, when using SpMV in an iterative solver application, many different input vectors may be multiplied with the same sparse input matrix 302 over the course of the application's execution. Therefore, in at least some implementations, the binning data is cached to reduce the overhead of repeated binning operations performed by the binning node 310.

The processor 202, in at least some implementations, implements a multi-stage process to cache the binning data. For example, during a first set of operations on the sparse input matrix 302 with a first input (e.g., a first input vector), the binning node 310 records the count of rows for each bin 314 into a separate buffer 322-1. This process is a “setup” phase, where the binning node 310 prepares the necessary information to facilitate efficient processing in subsequent operations. During a set of operations on the sparse input matrix 302 with a second input (e.g., a second input vector), instead of first launching the binning node 310, the processor 202 launches a preparation node first. Based on the counts accumulated during the first run, the preparation node sets up a pre-allocated buffer 322-2 (e.g., a work item buffer) with headers to identify subregions of the buffer 322-2 as input work items for the processing nodes 312. This process is a “preparation” phase, where the processor 202 prepares a data structure that can be used to optimize subsequent operations. After the preparation node has finished, the binning node 310 runs again. However, this time, the binning node 310 not only forwards the work items it produces to the processing nodes 312 but also copies those work items into corresponding locations in the newly pre-allocated buffer 322-2. This process ensures that the binning data is cached and can be reused in subsequent operations. In at least some implementations, after the binning node 310 finishes, the buffer 322-2 may be post-processed, for example, by sorting the work items to improve memory access locality in future runs. This additional process further optimizes performance by reducing the time it takes to access the cached data. Upon the third and all subsequent operations on the same sparse input matrix 302 with different inputs, the pre-allocated buffer 322-2 built up during the second set of operations includes the row-distribution to the different optimized processing nodes 310. Thus, rather than launching the binning node 310 again, the processor's work scheduler is able to directly launch the processing nodes 310 based on the cached input payloads. Stated differently, work items are able to be scheduled on processing nodes 310 without performing the binning and dispatching processes described above.

The techniques described above and the output vector 318 generated by the work graph 116 help drive computational tasks and decision-making processes, and are implemented by a computing system, such as computing system 100 or computing system 200, in various practical applications, such as graphics, gaming, machine learning, scientific simulations, data analytics, a combination thereof, and the like. In graphics and gaming, the output vector 318, in one example, is used for real-time physics simulations, where the positions and velocities of objects are updated based on physical interactions modeled by the sparse input matrix 302. For example, in a game environment, the output vector 318 can represent the new positions of particles or game objects after applying forces, collisions, or other interactions, leading to realistic and immersive gameplay experiences. As such, in these examples, the processor 202 uses the output vector 318 to update the game state, render graphics, perform physics and collision detection, manages animation, update AI and game logic, trigger sound and visual effect, synchronize data in multiplayer environments based on the new positions, a combination thereof, and the like.

In machine learning, the result output vector 318, in one example, represents the transformed feature space after applying a sparse transformation matrix to the input features. A computing system uses this transformation, for example, in techniques such as Principal Component Analysis (PCA) for dimensionality reduction or in the implementation of sparse neural networks for efficient inference, thereby directly impacting the performance and scalability of machine learning models. For instance, a recommendation system uses the output vector 318 to represent user preferences after transforming input user-item interaction data through a sparse matrix, aiding in predicting and recommending items to users based on their preferences, which enhances user engagement and satisfaction.

In scientific simulations, the output vector 318, in one example, represents the state of a system after applying a sparse interaction matrix. For example, in finite element analysis, the result output vector 318 includes displacements or stresses in a physical structure after applying force vectors to the nodes, enabling the analysis and optimization of structural designs. In another example, the output vector 318 is used to analyze the structural integrity of an aircraft wing by simulating the distribution of stresses and strains under various load conditions, leading to safer and more efficient designs.

In data analytics, the output vector 318, in one example, represents node centrality scores or other metrics after multiplying a sparse adjacency matrix with a vector of node attributes. This is useful for analyzing large-scale networks such as social media graphs or communication networks. For instance, a social media platform analyzes the influence of users within its network by using the output vector 318 to compute PageRank scores, identifying key influencers and optimizing content delivery strategies.

In solving linear programming and optimization problems, the output vector 318, in one example, represents intermediate solutions or gradients in iterative solvers, which is important for optimization techniques that handle sparse constraint matrices. For example, the output vector 318 is used to optimize supply chain logistics by solving large-scale linear programming problems involving sparse matrices of transportation costs and constraints, leading to cost reductions and improved efficiency in logistical operations.

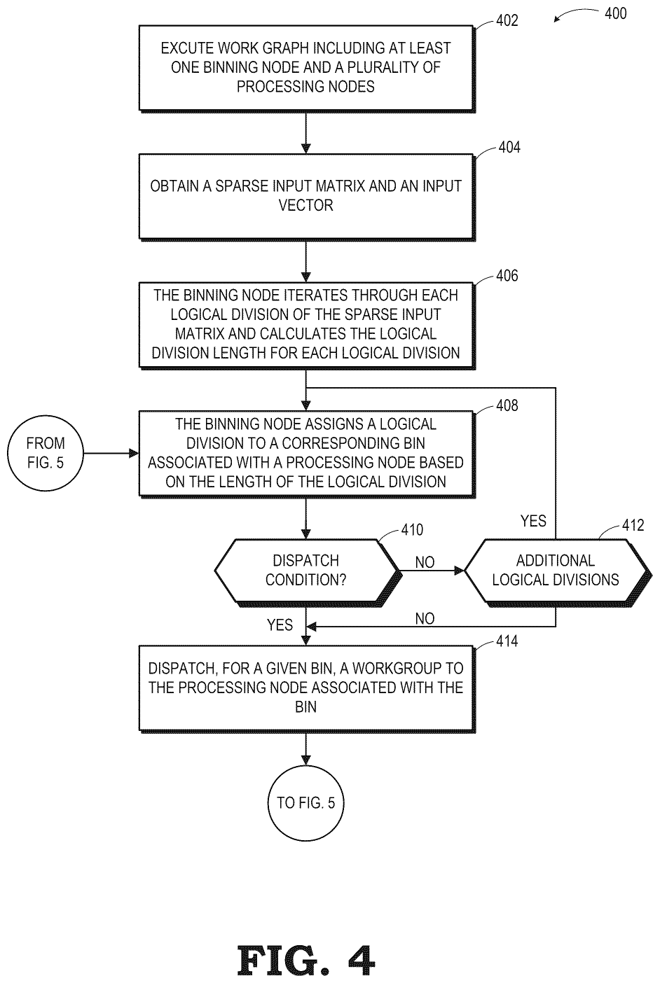

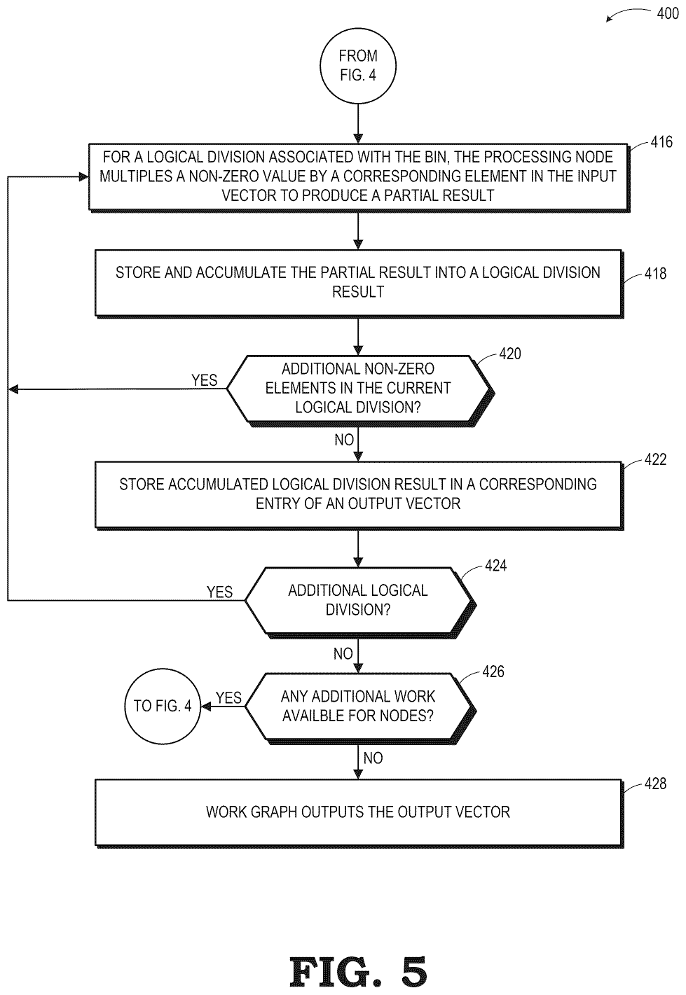

FIG. 4 and FIG. 5 together are a diagram illustrating an example method 400 of an overall process for performing sparse linear algebra operations, such as SpMV, using work graphs 116 executing at processor 202. It should be understood that the processes described below with respect to method 400 have been described above in greater detail with reference to FIG. 1 to FIG. 3. For purposes of description, the method 400 is described with respect to an example implementation at the computing system 100 of FIG. 1 or the computing system 200 of FIG. 2, but it will be appreciated that, in other implementations, the method 400 is implemented at processing devices having different configurations. Also, the method 400 is not limited to the sequence of operations shown in FIG. 4 and FIG. 5, as at least some of the operations can be performed in parallel or in a different sequence. Moreover, in at least some implementations, the method 400 can include one or more different operations than those shown in FIG. 4 and FIG. 5.

At block 402, the processor 202 defines and executes a work graph 116 for performing a sparse linear algebra operation, such as SpMV. The work graph 116 includes at least one binning node 310 and a plurality of processing nodes 312. At block 404, the processor 202 obtains a sparse input matrix 302 and an input vector 308. The sparse input matrix 402 has one or more different types of logical divisions of data (e.g., rows or columns). At block 406, the binning node 310 iterates through each logical division of the sparse input matrix 302 and calculates the logical division length for each logical division. For example, for CSR formatted data, the binning node 310 iterates through each row of the sparse input matrix 302 and calculates the row length for each row. For CSC formatted data, the binning node 310 iterates through each column of the sparse input matrix 302 and calculates the column length for each column. At block 408, the binning node 310 assigns a logical division (e.g., row or column) of the sparse input matrix 302 to a corresponding bin 314 associated with a processing node 312 based on the logical division length of the logical division. In at least some implementations, the binning node 310 stores work items, such as non-zero elements, column indices, row indices, or row identifiers, in data structures associated with the bin 314 for the rows assigned to the bin 314.

At block 410, the binning node 310 (or the command processor 226) determines if a dispatch condition has occurred for a bin 314. As described above, examples of a dispatch condition include the number of work items in a bin 314 satisfying a corresponding threshold, a cache locality of the work items satisfying a corresponding threshold, or any of a variety of other possible heuristics. If a dispatch condition has occurred, the process flows to block 414. However, if a dispatch condition has not occurred, at block 412, the binning node 310 determines if there are any additional logical divisions of the sparse input matrix 302 that need to be assigned to a bin 314. If there is at least one additional logical division left to process, the process returns to block 408. If all logical divisions have been assigned to a bin 314, the process ends if there is no further input work available at any of the binning node 310 or processing nodes 312. At block 414, the binning node 310 (or command processor 226) dispatches a workgroup, including work items, from the bin 314 to the processing node 310 associated with the bin 314.

At block 416, for a logical division associated with the bin 314, the processing node 312 multiples a non-zero value by a corresponding element in the input vector 308 to produce a partial SpMV result. At block 418, the processing node 312 stores and accumulates the partial results for the logical division into a logical division result. At block 420, the processing node 312 determines if any additional non-zero elements remain to be processed in the current logical division. If additional non-zero elements need to be processed, the process returns to block 416. At block 422, if all non-zero elements of the current logical division have been processed, the processing node 310 stores the accumulated logical division result in a corresponding entry of an output vector 318. At block 424, the processing node 310 determines if any additional logical division identified by the workgroup need to be processed. If additional logical division need to be processed, the process returns to block 416. At block 426, if no additional logical division need to be processed, the work graph 116 determines if any nodes (e.g., the binning node 310 or the processing nodes 312) have any available work. If either the binning node 310 or any processing node 312 has more work to perform, the process returns to block 408. At block 428, if the binning node 310 and processing nodes 312 have complete all their work, the work graph 116 outputs the output vector 318 generated by the processing nodes 312.

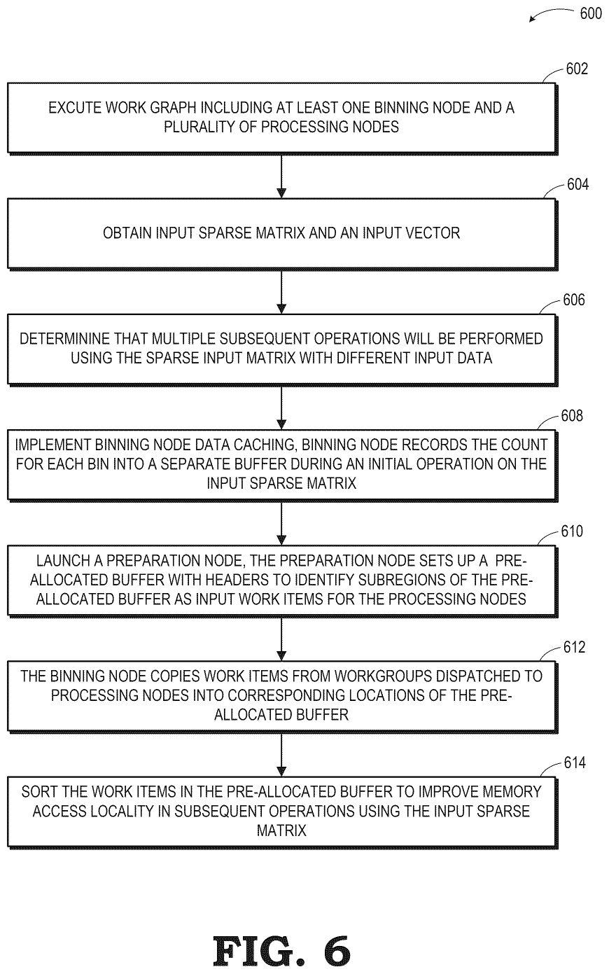

FIG. 6 is a diagram illustrating an example method 600 of a multi-stage process to cache the binning data generated by the binning node 310. It should be understood that the processes described below with respect to method 600 have been described above in greater detail with reference to FIG. 1 to FIG. 3. For purposes of description, the method 600 is described with respect to an example implementation at the computing system 100 of FIG. 1 or the computing system 200 of FIG. 2, but it will be appreciated that, in other implementations, the method 600 is implemented at processing devices having different configurations. Also, the method 600 is not limited to the sequence of operations shown in FIG. 6, as at least some of the operations can be performed in parallel or in a different sequence. Moreover, in at least some implementations, the method 600 can include one or more different operations than those shown in FIG. 6. In at least some implementations, the bin data caching operations described herein are performed in conjunction with or as part of blocks 408 to 414 of FIG. 4, although other configurations are applicable as well.

At block 602, the processor 202 defines and executes a work graph 116 for performing a sparse linear algebra operation, such as SpMV, as described above. At block 604, the processor 202 obtains a sparse input matrix 302 and a current input vector 308. At block 606, the processor 202 determines that multiple subsequent operations will be performed using the same sparse input matrix 302 but with different input data, such as different input vectors 308. At block 608, in response to this determination, the processor 202 implements binning node data caching and as the binning node 310 assigns work items (e.g., logical divisions, such as rows or columns) to each bin 314 (block 408 of FIG. 4) for the current SpMV operation, the binning node 310 records the work item count for each bin 314 into a separate buffer 322-1.

At block 610, a preparation node is executed in the work graph 116 that sets up a pre-allocated buffer 322 with headers to identify subregions of the pre-allocated buffer 322-2 as input work items for the processing nodes 310. At block 612, the binning node 310 executes again and copies the work items from the workgroups dispatched to the processing nodes 310 (block 414 of FIG. 4). At block 614, the binning node 310 or another node sorts the work items in the pre-allocated buffer 322-2 to improve memory access locality in subsequent SpMV operations using the same sparse input matrix 302. The binning data caching process then ends. As such, during subsequent SpMV operations on the same sparse input matrix 302, the binning node 310 does not need to be executed and the processor's work scheduler is able to launch the processing nodes 310 directly based off the input payloads cached in the pre-allocated buffer 322-2.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
executing, at a processor of a computing system, a work graph comprising a plurality of nodes representing kernels executable by one or more processing elements of the processor;
assigning, by a first node of the plurality of nodes, each logical division of a sparse input matrix to a bin of a plurality of bins; and
responsive to a dispatch condition associated with a bin of the plurality of bins, dispatching a workgroup to a second node of the plurality of nodes associated with the bin, the workgroup comprising a plurality of work items based on one or more logical divisions of the sparse input matrix assigned to the bin.

2. The method of claim 1, wherein assigning each logical division of the sparse input matrix to a bin of the plurality of bins comprises:
calculating, by the first node, a logical division length for each logical division of the sparse input matrix; and
assigning, by the first node, each logical division of the sparse input matrix to a bin of the plurality of bins based on the logical division length calculated for the logical division.

3. The method of claim 1, further comprising:
initializing, by the processor, the plurality of bins;
assigning, by the processor, each bin of the plurality of bins to a different range of logical division lengths; and
assigning, by the processor, one or more nodes of the plurality of nodes to each bin of the plurality of bins.

4. The method of claim 1, further comprising:
storing in memory, by the first node, a copy of the plurality of work items in the workgroup dispatched to the second node.

5. The method of claim 1, wherein the dispatch condition comprises at least one of a number of logical divisions of the sparse input matrix assigned to the bin satisfying a first threshold, or a cache locality of logical divisions of the sparse input matrix assigned to the bin satisfying a second threshold.

6. The method of claim 1, wherein further comprising:
performing, by the second node, one or more sparse linear algebra operations on the one or more logical divisions of the sparse input matrix assigned to the bin.

7. The method of claim 6, wherein performing the one or more sparse linear algebra operations comprises, for each logical division of the one or more logical divisions:
multiplying each non-zero value of the logical division by a corresponding element in an input vector to produce a partial result;
accumulating each partial result into a logical division result; and
storing the logical division result in an output vector.

8. A processor, comprising:
a plurality of processing elements,
the processor configured to execute a work graph comprising a plurality of nodes representing kernels executable by one or more processing elements of the plurality of processing elements,
a first processing element of the one or more of the processing elements associated with a first node of the plurality of nodes is configured to assign each logical division of a sparse input matrix to a bin of a plurality of bins, and
responsive to a dispatch condition associated with a bin of the plurality of bins, the processor is configured to dispatch a workgroup to at least a second processing element associated with at least a second node of the plurality of nodes corresponding to the bin, the workgroup comprising a plurality of work items based on one or more logical divisions of the sparse input matrix assigned to the bin.

9. The processor of claim 8, wherein the first processing element is configured to assign each logical division of the sparse input matrix to a bin of the plurality of bins by:
calculating a logical division length for each logical division of the sparse input matrix; and
assigning each logical division of the sparse input matrix to a bin of the plurality of bins based on the logical division length calculated for the logical division.

10. The processor of claim 8, wherein the processor is further configured to:
initialize the plurality of bins;
assign each bin of the plurality of bins to a different range of logical division lengths; and
assign one or more nodes of the plurality of nodes to each bin of the plurality of bins.

11. The processor of claim 8, wherein the first processing element is further configured to:
store in a memory of the processor a copy of the plurality of work items in the workgroup dispatched to the at least second processing element.

12. The processor of claim 8, wherein the dispatch condition comprises at least one of a number of logical divisions of the sparse input matrix assigned to the bin satisfying a first threshold, or a cache locality of logical divisions of the sparse input matrix assigned to the bin satisfying a second threshold.

13. The processor of claim 8, wherein the at least second processing element is configured to:
perform one or more sparse linear algebra operations on the one or more logical divisions of the sparse input matrix assigned to the bin.

14. The processor of claim 13, wherein the at least second processing element is configured to perform the one or more sparse linear algebra operations, for each logical division of the one or more logical divisions, by:
multiplying each non-zero value of the logical division by a corresponding element in an input vector to produce a partial result;
accumulating each partial result into a logical division result; and
storing the logical division result in an output vector.

15. A method comprising:
executing, at a processor of a computing system, a work graph comprising a plurality of nodes representing kernels executable by one or more processing elements of the processor; and
during a first set of operations on a sparse input matrix using a first input vector:
assigning, by a binning node of the plurality of nodes, each logical division of the sparse input matrix to a bin of a plurality of bins; and
storing, by the binning node for each bin of the plurality of bins, a logical division count in one or more buffers indicating a number of logical divisions of the sparse input matrix assigned to the bin.

16. The method of claim 15, further comprising:
during a second set of operations on the sparse input matrix using a second input vector, initializing, by a preparation node of the plurality of nodes, a work item buffer comprising headers identifying subregions of the work item buffer as input work items for processing nodes of the plurality of nodes.

17. The method of claim 16, further comprising:
during the second set of operations, dispatching, by the binning node, a workgroup to at least one processing node of the plurality of nodes comprising a plurality of work items based on one or more logical divisions of the sparse input matrix assigned to at least one bin of the plurality of bins associated with at least one processing node; and
storing a copy of the plurality of work items in corresponding locations of the work item buffer as the input work items.

18. The method of claim 17, further comprising:
during a third set of operations on the sparse input matrix using a third input vector, scheduling the plurality of work items on the at least one processing node of the plurality of nodes based on the copy of the plurality of work items stored in the work item buffer.

19. The method of claim 15, wherein assigning each logical division of the sparse input matrix to a bin of the plurality of bins comprises:
calculating, by the binning node, a logical division length for each logical division of the sparse input matrix; and
assigning, by the binning node, each logical division of the sparse input matrix to a bin of the plurality of bins based on the logical division length calculated for the logical division.

20. The method of claim 15, wherein assigning each logical division of the sparse input matrix to a bin of the plurality of bins comprises:
associating, by the binning node, at least a logical division identifier with the bin for each logical division assigned to the bin.
